(19) United States
(12) Patent Application Publication
(10) Pub. No.: US 2007/0281753 A1
(43) Pub. Date: Dec. 6, 2007

(54) User Interface and Communication System for a Motor Vehicle and Associated Operating Method

(75) Inventors: Guenter Dobler, Altbach (DE); Volker Entenmann, Affalterbach (DE); Siegfried Rothe, Denkendorf (DE); Cornelia Voigt, Aichwald (DE); Sven Willmann, Titisee-Neustadt (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/580,861

(22) PCT Filed: Nov. 10, 2004
(86) PCT No.: PCT/EP04/12688

§ 371 Date: Mar. 28, 2007

(30) Foreign Application Priority Data
Nov. 27, 2003 (DE) 103 55 476.9

(51) Int. Cl. H04M 1/02

(52) U.S. Cl. 455/569.1

(57) ABSTRACT

A user interface 4 for a communication system 2 in a motor vehicle 1 which, in a restricted operating mode, restricts a functionality of a radio interface 3 for wireless connection to a radio communication network and to a communication system 2 for a motor vehicle 1 with a radio interface 3 for wireless connection to a radio communication network and for setting up a corresponding communication link, and to an associated operating method. The user interface 4 activates a waiting function 4.1 for an incoming call in the restricted operating mode, which informs the caller of the cause and/or expected duration of the operation with restricted functionality.

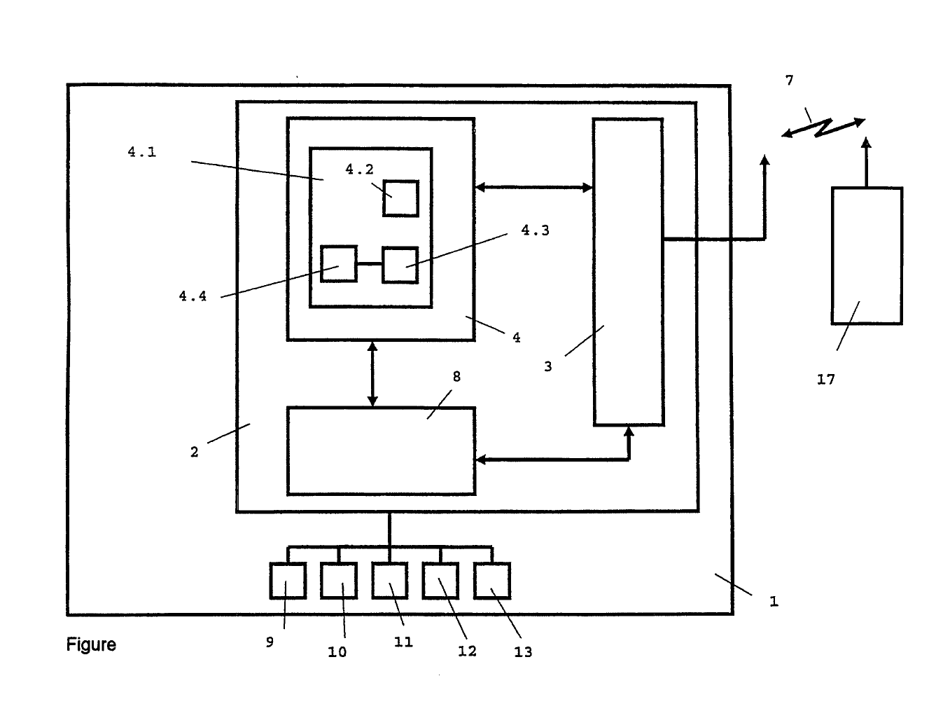

### BACKGROUND AND SUMMARY OF THE INVENTION

The invention relates to a user interface for a communication system in a motor vehicle and to a communication system for a motor vehicle to an associated operating method.

Telephone calls while driving represent a problem with regard to driving and traffic safety. Thus, driver distraction from his primary driving task and from observing the traffic environment resulting operating the telephone and by conducting the telephone call must be addressed.

Hands-free devices in the vehicle are known measures for counteracting these operating problems. Thus, for example, present-day vehicle series have steering wheel keys which enable the driver to receive or to end telephone calls when driving without having to take his hands off the steering wheel. However, there can be driving situations in which it is difficult to operate the steering wheel keys, for example in tight curves.

Apart from operating the telephone, however, the cognitive load on the driver due to the telephone call significantly contributes to the distraction. The driver must not neglect his observation of the other road users in spite of his concentration on the telephone call. In addition, the driver feels obliged, as a rule, to accept an incoming telephone call even when he is actually not able to do so due to the current driving situation.

Patent Document WO 03/001832 A1 describes a user interface and a communication system for a motor vehicle with a radio interface for wireless connection to a radio communication network and for setting up a corresponding communication link wherein a functionality of the radio interface is restrictable. The restriction of the radio interface consists in that, as a function of predeterminable conditions, incoming telephone calls are diverted into a mailbox which the driver can listen to at a later time. Such conditions are, for example, driving through sensitive local areas or a vehicle speed which is within predetermined speed ranges. The information about the sensitive local areas is supplied by a navigation system.

The prior German patent application of the applicant, not previously published, having the official file reference number 1030160477.4 relates to a user interface and a communication system for a motor vehicle and an associated operating method. In a restriction mode of operation, the user interface restricts a functionality of a radio interface for wireless connection to a radio communication network, wherein, in the restriction mode of operation, in the case of a call, the operation with restricted functionality is indicated to the caller and he is provided with a number of communication functions for selection. The user interface activates the selected communication function. The communication system includes means for detecting first and/or second traffic situations and for determining a radio communication as not feasible if one of the first traffic situations is detected and as feasible if one of the second traffic situations is detected. One of the selectable communication functions maintains the communication link and activates the call signal after a predeterminable time interval has elapsed.

The most frequent argument by customers against a suppression or diversion of telephone calls is that it could be a very important call which should not be missed under any circumstances because this could have grave consequences of a personal, professional or financial type.

It is, therefore, the object of the invention to provide an improved user interface and an improved communication system for a motor vehicle and an associated operating method in which calls not switched through or suppressed are dealt with and, as a result, disadvantageous consequences for the called party are almost completely prevented.

According to an aspect of the invention, a user interface is provided which activates a waiting function for an incoming call in a restricted operating mode, which informs the caller of the cause and/or expected duration of the operation with restricted functionality. This provides the caller with accurate information about the reason of the non-acceptance of the call by the called party. As a result, the caller recognizes that his call is being handled responsibly. The invention thus advantageously increases the readiness of the caller to maintain the connection until the called party is no longer occupied as much by the traffic event and can accept the call or to leave a message so that the called party can call back.

In an advantageous embodiment of the user interface, the indication of the restricted operating mode is arranged in dependence on the expected duration of the restricted operating mode and/or on the person of the caller.

The indication of the restricted operating mode include, for example, a voice output for outputting information and/or a sound output for bridging the waiting time. Thus, the indication of the restricted operating mode has two parts and include an information output part and a bridging part which makes the waiting time interesting to the caller.

In an advantageous embodiment of the user interface, the indication of the restricted operating mode include at least one output pause with adjustable duration. Due to this output pause, abrupt transitions between the voice output as information output and the sound output can be almost completely avoided. Because of the adjustability of the duration of the output pause, the length of waiting time indicated to the caller can be adhered to accurately. In the case of particularly short waiting times, the indication can be built up only from output pause and information output part. Thus, for example, a first output pause can be arranged after the call acceptance and before the indication of the information output part, and a second output pause can be arranged after the information output part and the connection to the driver.

In principle, the at least one output pause can be inserted before and/or after the information output and/or before and/or after the sound output. The length of the output pause can be advantageously adjusted by the system in such a manner that the waiting time announced is accurately adhered to, i.e. the announced waiting time is maintained by adjustment of the length of the output pause even if the driver could accept the call earlier than announced. This further improves the confidence of the caller in the system.

The arrangement of the indication can include at least two time ranges, one of which is selected in dependence on the expected duration determined for the restricted operating mode, the time range being selected which contains the value of the expected duration. As a result, the caller can receive a personal message of the called party about when he can receive the call. The time ranges can include, for example, the steps of 10, 15, 20, 25, 30, etc. seconds.

In an advantageous embodiment of the user interface, at least two indication variants are provided for the different time ranges, one of which can be selected, for example, by means of a random number generator.

In a further embodiment of the invention, the sound output includes discrete sound events and/or changeable sound events, wherein the changeable sound events can be achieved, for example, by varying a basic pattern by changing the instrumentation and/or the pitch and/or the register and/or the volume and/or the dynamic range and/or the speed and/or the rhythm and/or the tone sequence and/or the melody. In this context, the sound output should be arranged in such a manner that an implicit time information with regard to the length is contained so that the caller receives information about the waiting time still remaining. This can be conveyed to the caller, for example, via the pitch increasing towards the end of the waiting time. Conversely, a sound with decreasing pitch—like the behavior of an approaching sound source due to the Doppler effect—can also convey timing information. The sound of a metronome, for example, is also suitable, the rhythm of which becomes faster toward the end of the time interval, or an echo sounding signal, the sound of a bell or an acoustical signal simulating a siren with a dynamic range and/or rhythm which continuously changes in proportion to the decreasing waiting time so that, as a result, a tension bow builds up for the listener which is dissolved at the end of the waiting time as expected. A further possibility for conveying the timing information consists in that known musical items and melodies are played in dependence on the waiting time to be bridged, wherein a distance of a position in time within the musical item, with which the output of the musical item begins, calculated to the end of the musical item, is determined by the required duration for the sound output. If the required duration for the sound output is, for example, 11 s, the output of the musical item begins at the position within the musical item which is 11 s away from the end of the musical item. Since, as a rule, the caller knows the musical item, this will convey to him the associated timing information.

By dividing the possible callers into different categories, the called party can arrange the indications of the waiting function individually, for example by their own personal voice outputs.

Possible categories provided can be a private domain and/or a business domain and/or a neutral domain.

A communication system according to the invention for a motor vehicle with a radio interface for wireless connection to a radio communication network and for setting up a corresponding communication link includes the user interface described.

The invention increases the acceptance of the caller to wait until the called party can accept the call or to leave a message so that the called party can call back. For the called party, this ensures that really important calls are not simply lost. These and other features can also be found in the description and the drawings, apart from the claims, wherein the individual features in each case can be realized by themselves alone or several together in the form of sub-combinations in an embodiment of the invention and in other fields and can represent advantageous embodiments. In the text which follows, a practical exemplary embodiment will be described in greater detail with reference to the drawing.

### BRIEF DESCRIPTION OF THE DRAWINGS

The sole FIGURE shows a block diagram of a communication system with a user interface for a motor vehicle.

### DETAILED DESCRIPTION OF THE DRAWINGS

As can be seen from the FIGURE, the communication system 2 for a motor vehicle 1 comprises a radio interface 3 for the wireless connection of the communication system 2 to a radio communication network and for setting up a corresponding communication link 7, a user interface 4 according to the invention and means for detecting traffic situations 8. In the restricted operating mode, the user interface 4 restricts a functionality of the radio interface 3 so that, in the restricted operating mode, a caller cannot directly communicate with the user or driver via his terminal 17, for example a telephone, but with the user interface 4.

In the restricted operating mode, a call signal is suppressed in the case of an incoming call and a waiting function 4.1 is activated which informs the caller, for example by means of a voice output 4.2, about the cause and the expected duration of the restricted operating mode. If the caller is prepared to wait, the waiting function 4.1 maintains the communication link 7 and activates the call signal after the restricted operating mode has elapsed. The waiting function 4.1 arranges the indication of the restricted operating mode in dependence on the expected duration of the restricted operating mode and/or on the person of the caller. To implement the dependence of the indication on the person of the calling party, the called party can predetermine various categories so that a caller can be allocated to a category. Possible categories defined can be a private domain, a business domain and a neutral domain so that, for example, in the case of a private caller, a more personal voice output is effected than in the case of a business caller. In addition to the voice output 4.2 for information transmission, the waiting function 4.1 comprises a sound output 4.3 for bridging the waiting time. The sound output, too, can be predetermined in dependence on the category allocated to a caller so that, for example in the case of a private caller, the sound output is selected to be more personal than in the case of a business caller.

To arrange the indication, there are at least two time ranges, one of which is selected in dependence on the expected duration of the restricted operating mode determined, wherein the time range containing the value of the expected duration is selected. Thus, for example, the steps of 10, 15, 20, 25, seconds exist as time ranges. The following sentence can be output, for example, as voice output 4.2 “Due to a difficult traffic situation, I cannot accept your call at the moment. I will accept your call in 10/15/20/25/30 seconds”. In addition to the voice output 4.2, a sound output 4.3 with discrete sound events and/or with changeable sound events is then output which, for example by varying a basic pattern and/or by changing the instrumentation and/or the pitch and/or the register and/or the volume and/or the dynamic range and/or the speed and/or the rhythm and/or the tone sequence and/or the melody, is arranged to be interesting enough so that the caller maintains the connection until the called party can receive the call. This can be achieved by the fact that, the closer the end of the waiting time, a tension bow is built up by sound variation which abruptly dissolves at the end of the waiting time as expected. This can be conveyed to the caller, for example via the pitch of a sound signal which increases toward the end of the waiting time or conversely by means of a sound with decreasing pitch like the behavior of an approaching sound source due to the Doppler effect. For example, the sound of a metronome is also suitable, the rhythm of which becomes faster toward the end of the time period, or an echo sounding signal, the sound of a bell or an acoustical signal, simulating a siren, with a dynamic range and/or rhythm which continuously changes in proportion to the decrease in waiting time. This conveys an implicit timing information with regard to the length of the remaining waiting time to the calling party by corresponding arrangement of the sound. As has already been stated above, there is a further possibility for conveying the timing information in that known musical items and melodies are played in dependence on the waiting time to be bridged, a time interval of a position within the musical item with which the output of the musical item begins, calculated to the end of the musical item, being determined by the duration required for the sound output. Since, as a rule, the caller knows the musical item, this will convey to him the associated timing information. For each time range, at least two variants of indication are provided, i.e. with different sound outputs, one of which can be selected by means of a random number generator 4.4.

To avoid abrupt transitions between the individual output blocks, the indication of the restricted operating mode of the user interface 4 comprises at least one output pause with an adjustable duration. In addition, the length of the waiting time indicated to the caller can be accurately adhered to by means of the adjustability of the duration of the output pause. In the case of particularly short waiting times, the indication can be built up only of output pause and information output part. Thus, for example, in the case of a waiting time of approx. 10 s determined and the selected associated time range of 10 s after acceptance of the call and after the information output part in the form of the voice output 4.2, which takes 5 s, for example, an output pause with an adjusted length of 5 s can be arranged before the call connection to the driver is established.

In the exemplary embodiment shown, an output pause is inserted in each case after the information output and after the sound output. In the case of a time range of 20 s, selected in dependence on the waiting time, and a duration of 5 s for the voice output, the length of the sound output is set, for example, to 11 s and the length of the output pauses is in each case set to 2 s. In the case of a selected time range of 30 s, the length of the sound output is set, for example, to 21 s and the length of the output pauses is in each case set to 2 s. In this manner, the waiting times announced to the caller can be accurately maintained, i.e. the announced waiting time is maintained by the adjustment of the length of the output pause even if the driver could accept the call earlier than announced. This further improves the confidence of the caller in the system.

The user interface 4 according to the invention also include the possibility that the driver can divide the possible callers into various categories and can determine a separate personal voice and/or sound output for each of the categories, wherein the caller is recognized due to his telephone number. The various categories include, for example, a private domain and/or a business domain and/or a neutral domain.

For the activation of the restricted operating mode and for determining the expected duration of the restricted operating mode which, for example, is activated in dependence on predeterminable traffic situations, the communication system 2 receives via corresponding connecting lines data to be evaluated from a navigation system 9, a direction finding system 10, a digital map 11, at least one driver assistance system 12 and at least one vehicle sensor 13. In addition, the communication system 2 receives via the radio interface 3 floating car data (FCD) and/or extended floating car data (XFCD) from vehicles, not shown. For the automatic activation of the restricted operating mode and for determining the expected duration, the communication system 2 shown comprises means for detecting traffic situations 8 which evaluate the data from a navigation system 9 and/or from a direction finding system 10 and/or from vehicles and/or from a digital street map 11 in order to determine first route sections with first traffic situations and/or second route sections with second traffic situations, first and/or second traffic situations being detected and it being determined that a radio communication cannot be effected when one of the first traffic situations is detected and that a radio communication can be effected when one of the second traffic situations is detected.

The restricted operating mode of the user interface 4 is activated when one of the first traffic situations is detected. To evaluate whether a current traffic situation is one of the first or one of the second traffic situations, the means for detecting traffic situations 8 evaluate data from at least one driver assistance system 12 and/or from at least one vehicle sensor 13. Evaluating these data makes it possible to detect, for example, driving maneuvers which correspond to a first traffic situation such as braking and acceleration phases, severe steering maneuvers, imminent collision with a preceding vehicle, etc. The evaluation of the data of the navigation system 9 with a direction finding system 10 and a digital map 11 can also lead to the detection of a first traffic situation which does not relate to the current traffic situation but to a traffic situation which will occur shortly in which a radio communication cannot be carried out, such as, for example, driving into a tunnel, onto a large intersection or into a construction site. This anticipatory detection of such critical traffic situations prevents a radio communication from being permitted initially due to the currently detected second traffic situation even though a first traffic situation is detected shortly after acceptance of the call.

The at least one driver assistance system 12 include, for example, an anti-blocking system and/or an anti-collision system and/or a wheel slip system and/or a parking support system and/or a lane detection system and/or an alertness monitoring system.

1-24. (canceled)

25. A user interface for a communication system in a motor vehicle which, in a restricted operating mode, restricts a functionality of a radio interface for wireless connection to a radio communication network, said interface including a device for activating a waiting function for an incoming call in a restricted operating mode, which informs the caller of at least one of the cause and expected duration of the operation with restricted functionality.

26. The user interface as claimed in claim 25, further comprising a device for determining an expected duration of the restricted operating mode.

27. The user interface as claimed in claim 25, wherein the waiting function arranges an indication of the restricted operating mode in dependence on at least one of the expected duration of the restricted operating mode and the person who is calling.

28. The user interface as claimed in claim 27, wherein the indication comprises at least one of a voice output for outputting information and a sound output for bridging the waiting time.

29. The user interface as claimed in claim 27, wherein the indication comprises at least one output pause with an adjustable duration.

30. The user interface as claimed in claim 29, wherein the at least one output pause can be inserted at least one of before or after the information output and before or after the sound output.

31. The user interface as claimed in claim 27, further including at least two time ranges provided for arranging the indication, one of said at least two ranges is selected in dependence on the expected duration determined for the restricted operating mode, wherein the time range containing the value of the expected duration is selected.

32. The user interface as claimed in claim 31, wherein for each time range, at least two indication variants are provided, and one of said variants is selected by means of a random number generator.

33. The user interface as claimed in claim 31, wherein the sound output comprises at least a part of a known musical item, wherein a time position within the musical item with which the sound output begins, calculated to the end of the musical item, corresponds to the required duration for the sound output for bridging the waiting time.

34. The user interface as claimed in claim 31, wherein the sound output comprises at least one of discrete sound events and changeable sound events.

35. The user interface as claimed in claim 34, wherein the changeable sound events are achieved by varying a basic pattern by changing at least one of the instrumentation and the pitch and the register and the volume and the dynamic range and the speed and the rhythm and the tone sequence and the melody.

36. The user interface as claimed in claim 35, wherein an acoustic echo sounding signal or a metronome signal is used as basic pattern.

37. The user interface as claimed in claim 34, wherein the sound events are changed in proportion to the decreasing waiting time.

38. The user interface as claimed in claim 37, wherein possible callers are divided into different categories, the different categories in each case comprising separate personal voice outputs of the user.

39. The user interface as claimed in claim 38, wherein the different categories comprise at least one of a private domain and a business domain and a neutral domain.

40. A communication system for a motor vehicle with a radio interface for wireless connection to a radio communication network and for setting up a corresponding communication link, including a user interface according to claim 25.

41. An operating method for a communication system in a motor vehicle, the functionality of which is restricted in dependence on predetermined conditions in operation, said method comprising:
activating, in the operation with restricted functionality, a waiting function with an incoming call determining the expected duration of the restricted mode; and
informing the caller about at least one of the cause and the expected duration of the operation with restricted functionality.

42. The operating method as claimed in claim 41, wherein an indication of the restricted operating mode is arranged in dependence on at least one of the expected duration of the restricted operating mode and the person calling.

43. The operating method as claimed in claim 42, wherein the indication is output to the caller as at least one of voice output for information output and sound output for bridging the waiting time.

44. The operating method as claimed in claim 42, wherein the indication comprises at least one output pause with adjustable duration.

45. The operating method as claimed in claim 44, wherein the at least one output pause is inserted at least one of before or after the information output and before or after the sound output.

46. The operating method as claimed in claim 43, wherein the sound output comprises at least one of discrete sound events and changeable sound events.

47. The operating method as claimed in claim 46, wherein the changeable sound events are achieved by variation of a basic pattern by changing at least one of the instrumentation and the pitch and the register and the volume and the dynamic range and the speed and the rhythm and the tone sequence and the melody.

48. The operating method as claimed in claim 46, wherein the sound events are changed in proportion to a decreasing waiting time.
